(19) United States
(12) Patent Application Publication
(10) Pub. No.: US 2007/0245783 A1
(43) Pub. Date: Oct. 25, 2007

(54) Adjustable Two-Piece Vehicle Immobilizer

(75) Inventors: Robert A. Fulcher, Grand Junction, CO (US); Allan E. Beavers, Grand Junction, CO (US)

Correspondence Address: SHERIDAN ROSS PC, 1560 BROADWAY, SUITE 1200, DENVER, CO, 80202, US

(73) Assignee: MITI MANUFACTURING COMPANY, Grand Junction, CO (US)

(21) Appl. No.: 11/736,859

(22) Filed: Apr. 18, 2007

Related U.S. Application Data
(60) Provisional application No. 60/745,160, filed on Apr. 19, 2006.

(51) Int. Cl. B60R 25/00; B60T 3/00

(52) U.S. Cl. 70/226; 188/32

(57) ABSTRACT

A two-piece vehicle immobilizing device adapted for removable interconnection to a vehicle wheel assembly. The vehicle immobilizing device utilizes an outer arm, an inner arm with inner and outer indexing stops, an engagement dome, and a securing mechanism that provides engagement to the vehicle wheel assembly to prevent unauthorized removal.

This patent application claims the benefit of U.S. Provisional Patent Application Ser. No. 60/745,160, filed Apr. 19, 2006, which is incorporated by reference in its entirety herein. This application is also related to U.S. Pat. Nos. 5,865,048, 6,032,497, D489,597 and D385,525 issued Feb. 2, 1999, Mar. 7, 2000, May 11, 2004 and Oct. 28, 1997, respectively, which are all incorporated by reference in their entirety herein.

### FIELD OF THE INVENTION

The present invention relates to a device and method for selectively immobilizing wheeled vehicles to inhibit theft or the unauthorized movement thereof.

### BACKGROUND OF THE INVENTION

The use of immobilizers to prevent the unauthorized movement of automobiles and other wheeled vehicles is well known. Immobilizers are designed to prevent theft or to insure the payment of parking fines. Vehicle immobilizers are widely used by law enforcement personnel, parking attendants, city governments, and individuals concerned with the theft of vehicles. Unfortunately, the vehicle immobilizing devices currently known in the art are difficult to install, may cause vehicle damage, are prone to being removed by unauthorized personnel, and are not versatile for use on a variety of vehicles and wheel assemblies.

One problem associated with many vehicle immobilizer designs is the ease of which they can be removed by irate vehicle owners or thieves. This ease of removal is often attributed to inadequate contact between the immobilizer and the vehicle wheel assembly. As used herein, the term “vehicle wheel assembly” is generally defined as a vehicle wheel with or without a hubcap, an interconnected tire, a brake mechanism, a wheel rim, and in some vehicle designs, tie rods that are employed for support and/or steering purposes. The brake mechanism may further include a drum or disk brake with, or without, a brake backing plate. Without adequate points of contact, the vehicle immobilizer may be pried, cut and/or pulled off the vehicle. For example, immobilizer disengagement may be achieved by a release of tire pressure, thereby altering the wheel assembly/immobilizer interface and allowing the device to be removed from the wheel assembly. Vehicle immobilizers disclosed in U.S. Patent No. RE024,712 to Marugg and U.S. Pat. No. 2,960,857 to Winter both employ only three points of engagement on the vehicle wheel assembly, which is generally insufficient to prevent unauthorized removal.

Another problem associated with many types ofvehicle immobilizers is the difficulty associated with installation and removal. This is generally due to the immobilizer's weight and the fact that the inner and outer arm assemblies that engage the wheel assembly must be precisely positioned in a very limited space. Thus, proper installation of the wheel immobilizer is time consuming and often performed improperly, resulting in vehicle wheel assembly damage or easier unauthorized removal. For example, U.S. Pat. No. 5,865,048, to Beavers et al, teaches a wheel immobilizer that includes an inner arm and stopping member that are adapted to selectively interconnect to a wheel and a brake backing plate. In order to ensure proper placement, a user must physically reach in between the wheel and the brake backing plate to feel where a wheel lip is located in order to properly align the stopping member prior to the final installation step of tightening a locking bolt.

Yet another problem associated with many types of vehicle immobilizers is damage to the vehicle inner wheel, outer wheel, wheel rims, hubcaps and/or braking mechanisms that may occur during installation. The damage to the hubcap and or outer wheel rim is the result of force and associated abrasion from a rigid metallic plate or arm assembly that is pressed against the hubcap or outer wheel. Any prying or movement of the arm assembly that may often occur during installation or attempts to forcibly remove the immobilizer from the vehicle will permanently scratch and/or dent the hubcap or outer wheel. The outer and inner wheel rims may also be damaged by many types of vehicle immobilizing devices as a result of the rigid, non-moving rim jaws that engage the inner or outer rim, as shown in U.S. Pat. No. 2,960,857 to Winter. Any prying of the vehicle immobilizer may result in the rims becoming bent or scratched. Furthermore, since rim jaws are not capable of moving in a longitudinal and/or horizontal direction, the vehicle immobilizer cannot be properly fitted to numerous types and sizes of wheel assemblies, thus resulting in inadequate installation.

A final problem associated with many vehicle immobilizing devices is a lack of versatility for use on a variety of models of wheel assemblies and automobiles. More specifically, even for a certain size or model of vehicle, many immobilizers cannot be used interchangeably on both vehicle sides. Thus, installers must have numerous models of immobilizers in stock for a variety of vehicles rather than utilize a versatile, universal immobilizer capable of use on a variety of vehicles and wheel assemblies.

### SUMMARY OF THE INVENTION

One embodiment of the present invention is a two-piece vehicle immobilization device that incorporates one or more of the following aspects. A first half of the two-piece device serves to immobilize a vehicle wheel assembly and a second half of the two-piece device serves to prevent separation of the first half from the vehicle wheel. The first half of the immobilizer engages an inner portion and an outer portion of a rim of the wheel rim assembly. The second half utilizes a dome to cover the outer face of the wheel serving to prevent the removal of the wheel when the immobilization device is installed. The dome may be deep dished to prevent contact with vehicle wheel assembly components other than those engaged by an edge of the dome. Further, the edge of the dome may be cushioned to reduce possible damage to the exterior face of the wheel. In addition, the dome may be adjustable by at least one of a hinged connection and a telescoping feature so that it may be properly positioned on the outer face of the vehicle wheel thereby securing lug nuts that interconnect the wheel to an axle of the vehicle. In one embodiment, the second half is associated to the first half by a stud connection located in a housing. In order to prevent access to the stand connection a cover may be selectively secured to the housing, preferably with a pad lock. Due to the orientation of the installed immobilizer, the pad lock may be partially hidden, adding to the difficulty of unauthorized removal of the immobilizer.

Embodiments of the present invention also utilize a wide welded steel base and tightening bolt to enable attachment to various vehicle wheel assemblies. The base may also be equipped with a pair of loops that can operate either as a stand when the immobilization device is installed or as carrying handle for the device.

Although steel construction has been briefly mentioned, other strong and durable materials may be employed to obtain the desired balance of cost, weight and strength of the immobilizer.

Thus it is one aspect of embodiments of the present invention to provide a two-piece vehicle immobilizer that includes:

a first half that includes:
a base,
an outer arm having a first end and a second end, said first end interconnected to said base,
an inner arm having a first end and a second end, said first end hingedly interconnected to said base, and
an indexing loop interconnected to said second end of said inner arm for engagement with the wheel;
a securing member selectively interconnected to said base that engages said first end of said inner arm, thereby preventing said second end of said inner arm from moving outwardly from said second end of said outer arm; and
a second half for selective interconnection to said first half that includes:
a dome for engagement to the wheel interconnected to said outer arm second end of said first half.

It is another aspect of embodiments of the present invention to provide a method of immobilizing a vehicle comprising:

providing a base assembly with an inner arm rotatably associated with an outer arm, which has a threaded stud protruding therefrom, and a securing member that selectively prevents said inner arm from moving outwardly from said outer arm;

interconnecting said inner arm to an inner portion of the wheel rim;

interconnected said outer arm to an outer portion of the wheel rim;

tightening said securing member, thereby fastening said base assembly to the vehicle wheel assembly;

providing a dome assembly with a plate with an aperture therein interconnected to a beam, wherein said beam is also slidingly engaged to a sleeve that is rotatably interconnected to a dome;

positioning said dome over the wheel;

selectively adjusting said sleeve to position said stud through said aperture;

tightening a nut onto said stud to interconnect said base assembly to said dome assembly.

This Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a top plan view of a first half of a vehicle immobilizer;

FIG. 2 is a right elevation view of the first half of the vehicle immobilizer shown in FIG. 1;

FIG. 3 is a bottom plan view of a second half of the vehicle immobilizer;

FIG. 4 is a left elevation view of the second half of the vehicle immobilizer shown in FIG. 3;

FIG. 5 is a top plan view of a two-piece vehicle immobilizer;

FIG. 6 is a top plan view of the two-piece vehicle immobilizer;

FIG. 7 is a left elevation view of the two-piece vehicle immobilizer;

FIG. 8 is a front elevation view of the two-piece vehicle immobilizer;

FIG. 9 is a right elevation view of the two-piece vehicle immobilizer;

FIG. 10 is a detailed view of FIG. 9, wherein an inner arm of the first half has been removed for clarity;

FIG. 11 is a rear perspective view of the first half of the vehicle immobilizer interconnected to a vehicle wheel; and

FIG. 12 is a rear perspective view of the two-piece vehicle immobilizer interconnected to a vehicle wheel.

To assist in the understanding of the present invention the following list of components and associated numbering found in the drawings is provided herein:

| # | Component |
|---|---|
| 3 | Vehicle immobilizer first half |
| 6 | Vehicle immobilizer second half |
| 9 | Inner arm |
| 12 | Tire |
| 15 | Inner index stop |
| 18 | Wheel |
| 21 | Outer index stop |
| 24 | Wheel rim |
| 27 | Pad |
| 30 | Outer arm |
| 33 | Spring |
| 36 | Bolt |
| 39 | Stud |
| 42 | Plate |
| 45 | Adjustment slot |
| 48 | Housing |
| 51 | Nut |
| 54 | Cover |
| 57 | Padlock |
| 60 | Vehicle immobilization device |
| 63 | Dome |
| 66 | Lug nuts |
| 69 | Base |
| 72 | Hinge |
| 75 | Cylinder |
| 78 | Stand |
| 81 | Beam |
| 84 | Cushioned edge |
| 87 | Sleeve |
| 90 | Channel |
| 93 | Lanyard |
| 96 | Protrusion |
| 99 | Aperture |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

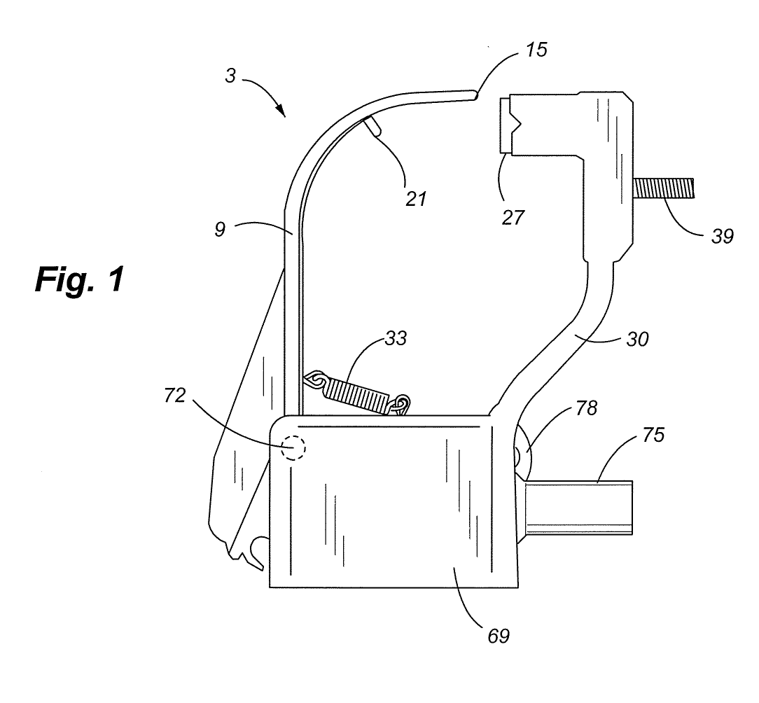

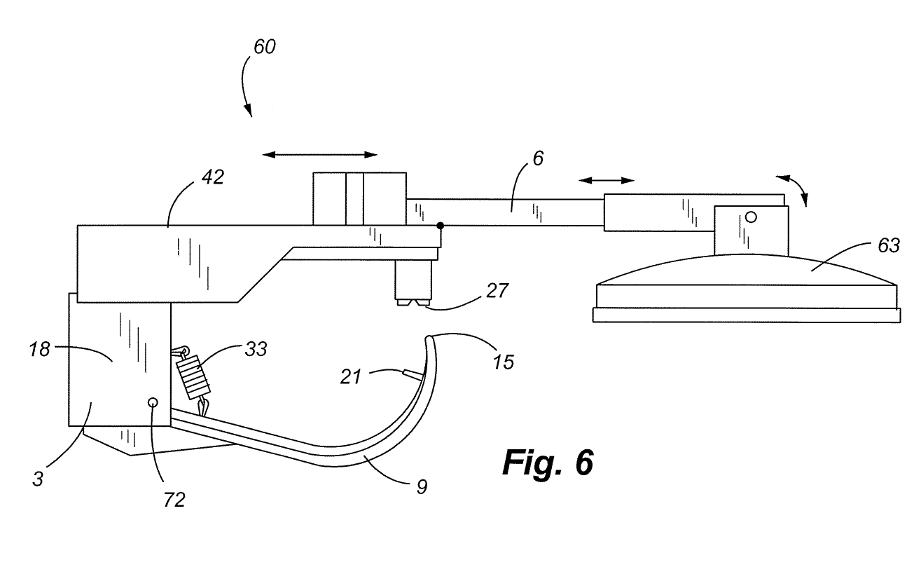

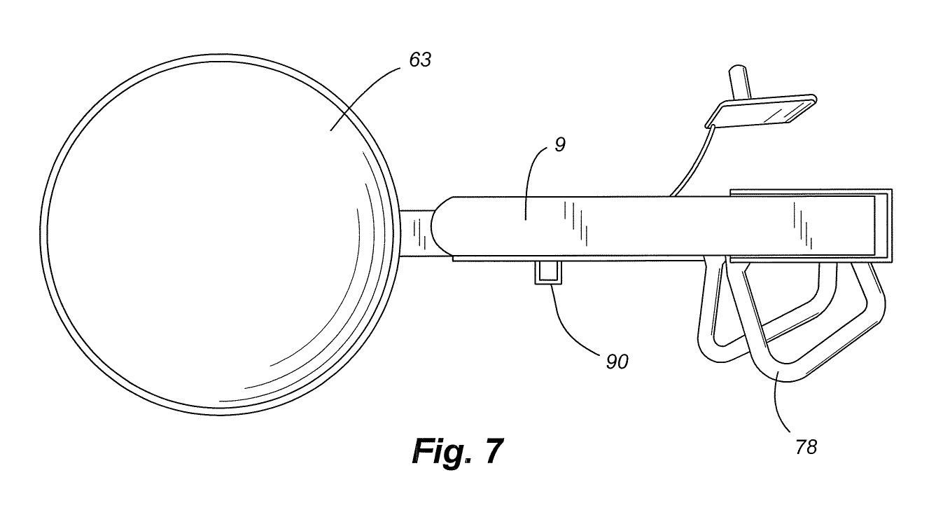

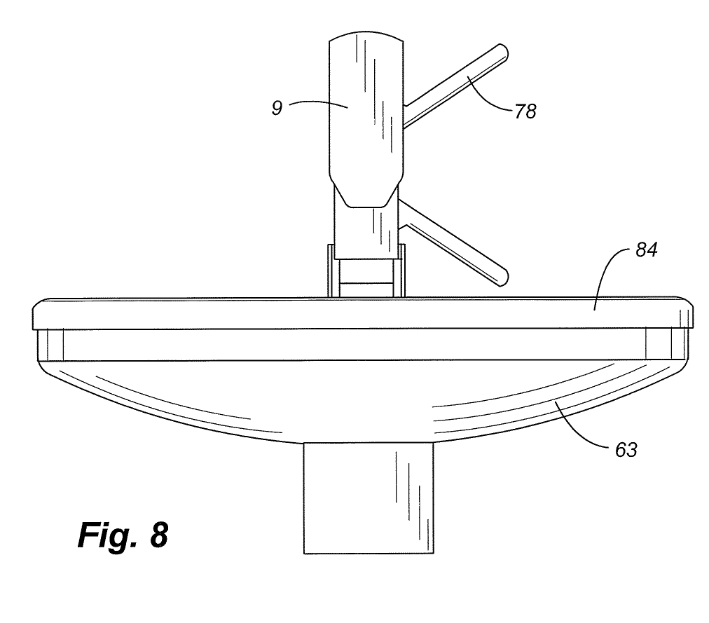

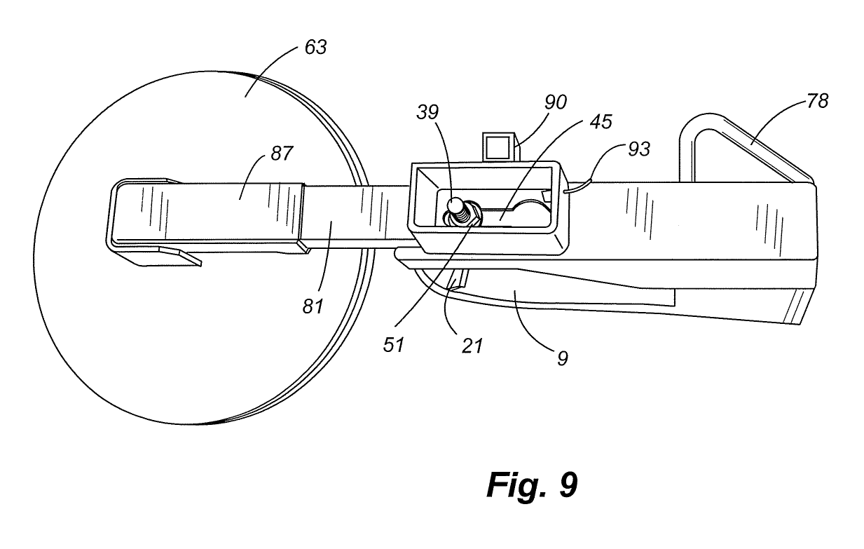

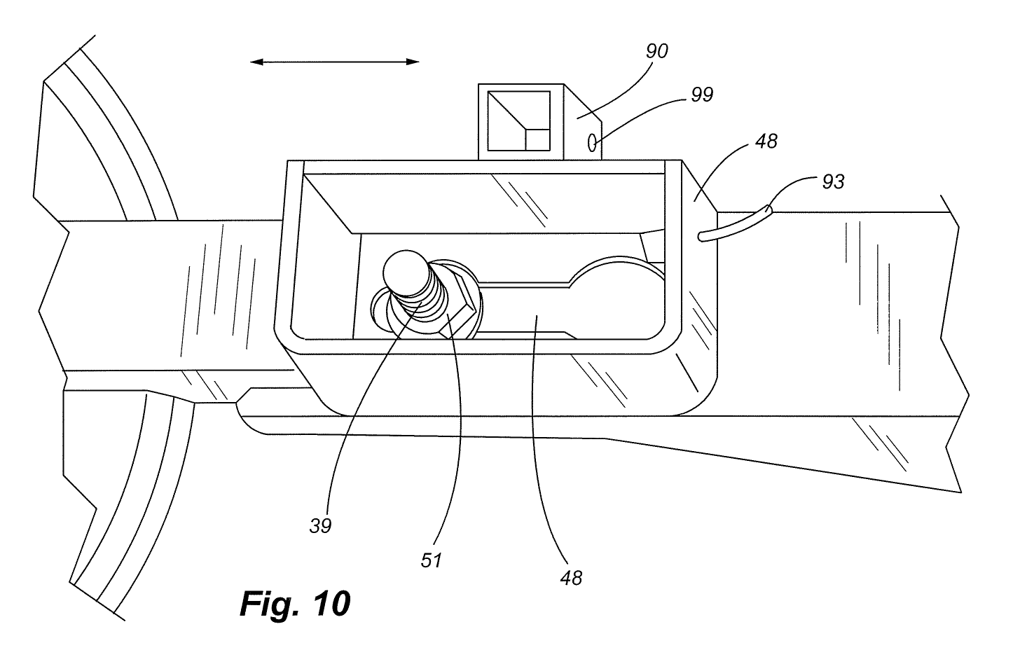

Referring now to FIGS. 1-13, one embodiment of the present invention that includes a vehicle immobilizer first half 3 for interconnection to a vehicle immobilizer second half 6 is provided. More specifically, in operation, an inner arm 9 of the vehicle immobilizer first half 3 is engaged to the inner sidewall of a tire 12 wherein an inner index stop 15 is engaged to the inner diameter of the wheel 18 and an outer index stop 21 is engaged to the outer diameter of an inner wheel rim 24 adjacent the inner sidewall of the tire 12. In addition, a pad 27 integrated onto the outer arm 30 of the vehicle immobilizer first half 3 is engaged to an outer edge of the outer wheel rim 24. A spring 33 positioned between the inner arm 9 and the outer arm 30 tends to bias the ends of the inner arm 9 and the outer arm 30 onto the wheel 18. In order to ensure that the inner arm 9 is not transitioned outwardly, thereby allowing disengagement of the vehicle immobilizer first half 3, a tightening bolt 36 is provided that when rotated clockwise, pushes on a second end of the inner arm 9 to force the first end of the inner arm 9 tightly onto the wheel 18.

Next, the vehicle immobilizer second half 6 is interconnected to the vehicle immobilizer first half 3 via a stud 39 provided on the outer arm 30 of the vehicle immobilizer first half 3. The vehicle immobilizer second half 6 also includes a plate 42 that hides the tightening bolt 36 such that an individual cannot easily gain access thereto. The stud 39 of the outer arm 30 of the vehicle immobilizer first half 3 is slid through an adjustment slot 45 provided on the vehicle immobilizer second half 6. This adjustment slot 45 is located within a housing 48 incorporated onto the vehicle immobilizer second half 6. A nut 51 is then threaded onto the stud 39, thereby interconnecting the two halves together. Finally, a cover 54 is locked to the housing with a padlock 57 to securely affix the vehicle immobilization device 60 to the vehicle. The vehicle immobilizer second half 6 also includes a dome 63 that engages the exterior face of the wheel 18 and/or hub cap of the vehicle to prevent an individual from removing the lug nuts 66 of the wheel 18.

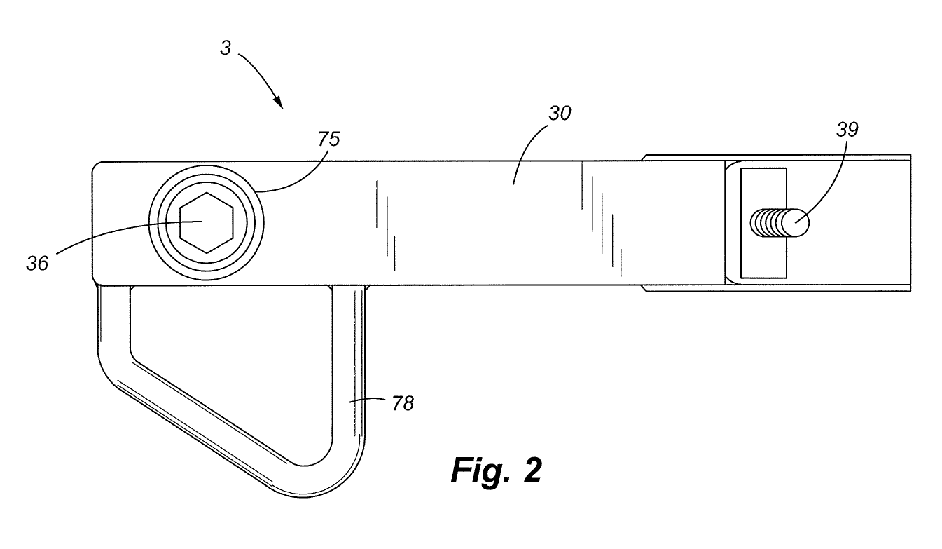

Referring now primarily to FIGS. 1 and 2, the immobilizer first half 3 of one embodiment includes a base 69 with an outer arm 30, which is preferably rigidly connected thereto, and a hingedly connected inner arm 9. The outer arm 30 extends from the base 69 at an angle sufficient to clear the width of the tire and culminates in a pad 27 that engages the outer edge of the outer wheel rim 24 without damaging its surface. Further, the outer arm 30 has a stud 39 extending outwardly for interfacing with immobilizer second half. The first end of the inner arm 9 has a first portion that engages the inner surface of the tire sidewall and a second portion that engages the wheel. A second portion of the inner arm 9 has an outer index stop 21 that engages the inner diameter of the wheel and an outer index stop 21 that engages the outer diameter of the inner wheel rim adjacent the inner sidewall of the tire. Combined with the pad 27, the inner 15 and outer 21 index stops interconnect the immobilizer first half 3 to the vehicle wheel and tire. A spring 33 attached to the first end of the inner arm 9 and to the base 69 providing torque about a hinge 72 that tends to bring the inner 9 and outer 30 arms together against the vehicle wheel and tire. The base 69 includes a bolt 36 housed by a cylinder 75. Upon clockwise rotation, the bolt 36 provides pressure on the end of the inner arm 9 that is positioned near the base 69 to prevent the inner index stop 15 from rotating in a direction away from the outer arm 30. Further, an embodiment of the base is equipped with a stand 78 that positions the base 69 away from the ground and which acts as a handle to facilitate installation.

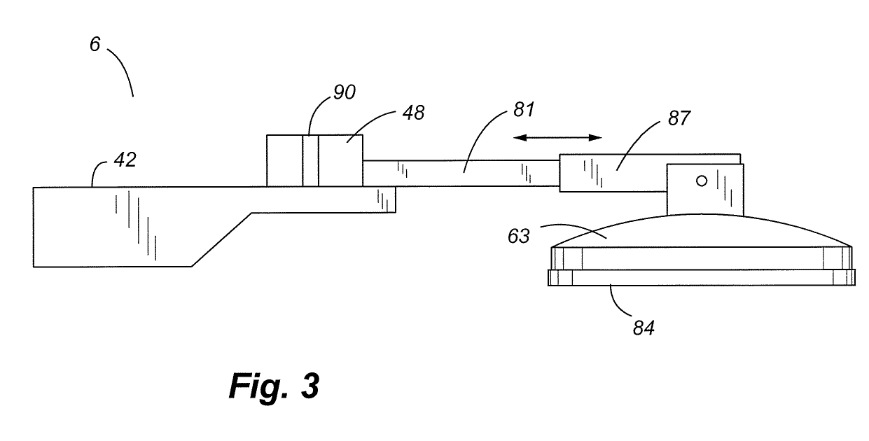

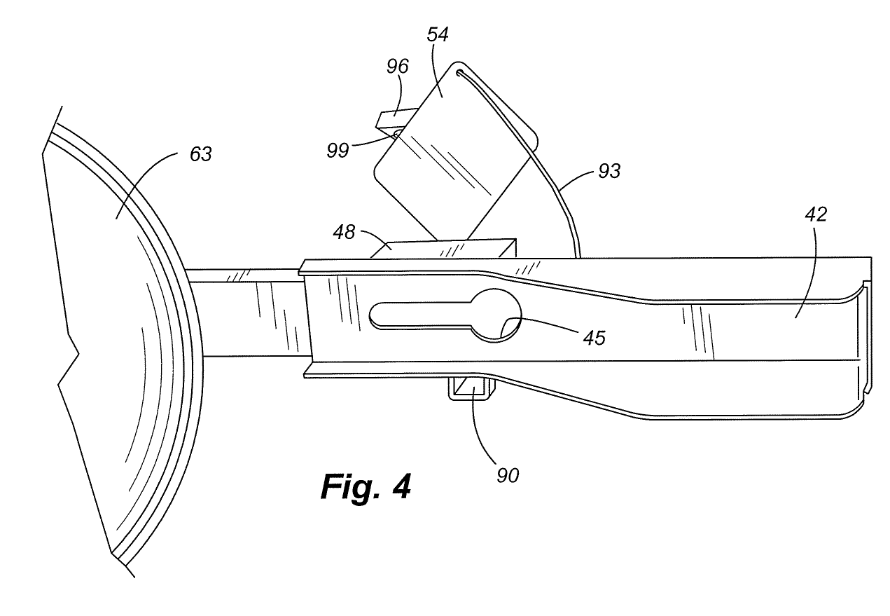

Referring now primarily to FIGS. 3 and 4, the immobilizer second half 6 is provided that includes a dome 63 connected to a plate 42 via a beam 81. In one embodiment, the dome 63 is of a diameter sufficient to cover the lug nuts 66 securing the wheel, thereby preventing the wheel from being removed from the vehicle while the vehicle immobilization device 60 is attached. Further, the dome 63 may be equipped with a cushioned edge 84 so that damage to the exterior face of the wheel 18 is avoided. An additional embodiment of the dome 63 includes a hinged connection to a sleeve 87 to aid in placement and integration of the dome 63 over the wheel. Further, the sleeve 87 may be slidingly interconnected to the beam 81, thereby providing axial adjustment. The plate 42 is equipped with a housing 48 and a channel 90 located adjacent to the housing 48. The housing 48 preferably includes a removable cover 54 that is equipped with a lanyard 93 attached to the plate 42 to prevent the cover 54 from being lost. Further, the plate 42 may be equipped with a protrusion 96 that fits inside the channel 90 when the cover 54 is placed over the housing 48 to help ensure proper cover alignment. An adjustment slot 45 adapted for securing the stud 39 is located on the plate 42 behind the housing 48. This adjustment slot 45 is larger at one end to permit the insertion of the stud 39 with a nut 51 already attached and is accessible only upon removal of the housing cover 54.

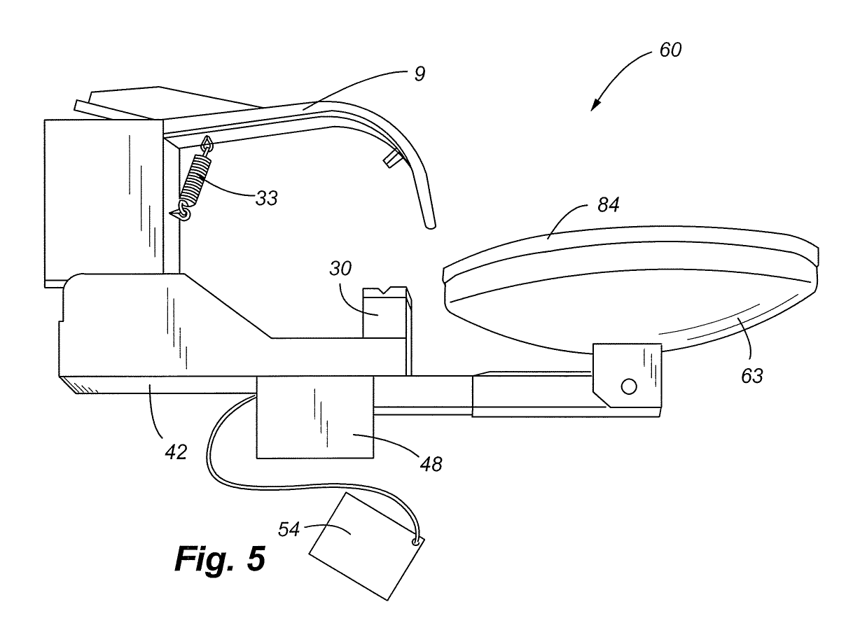

Referring now primarily to FIGS. 5-10, the vehicle immobilization device 60 comprises the union of the vehicle immobilizer first half 3 and the vehicle immobilizer second half 6. The plate 42 of the immobilizer second half 6 fits substantially over the outer arm 30 of the immobilizer first half 3. Upon assembly, the plate 42 of the immobilizer second half 6 completely covers the cylinder 75 and adjustment bolt 36 of the immobilizer first half 3. Further, the stud 39 on the immobilizer first half 3 is inserted through the adjustment slot 45 on the immobilizer second half 6. In one embodiment, the stand 78 comprises at least one, preferably two, u-shaped loops extending from the bottom of the base downward and to each side. The loops provide a stable platform for the immobilizer and prevent the base 69 from resting on the ground. Further, the u-shaped loops provide handholds for aiding the movement and adjustment of the vehicle immobilization device 60.

In operation, the immobilizer first half 3 and immobilizer second half 6 are joined together via the stud 39. The stud 39 is inserted through the adjustment slot 45 in the plate 42 of the immobilizer second half 6 and secured by the nut 51. The length of the adjustment slot 45 permits axial adjustments of the vehicle immobilization device 60. The channel 90 and the protrusion 96 on the cover 54 include matching apertures 99 for the attachment of a padlock 57 that prevents removal of the cover.

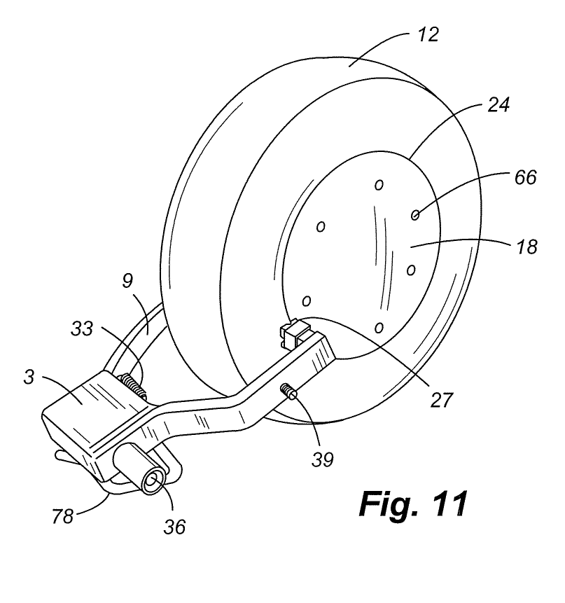

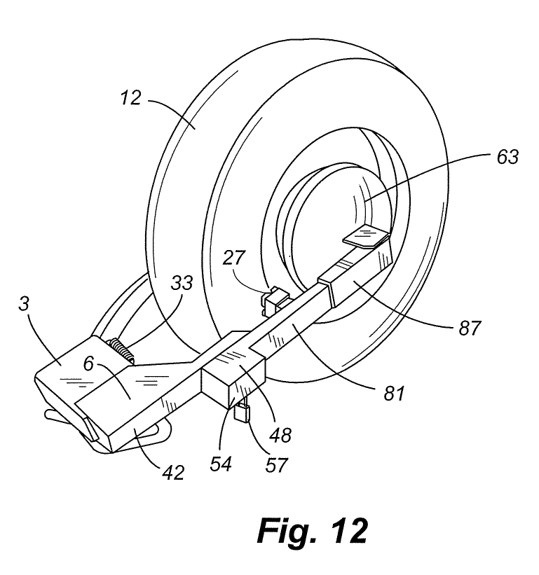

Referring now primarily to FIGS. 11 and 12, the vehicle immobilization device 60 is attached by first positioning the vehicle immobilizer first half 3 in front of or behind one of the vehicle tires 12. The inner arm 9 is separated from the outer arm 30 by a distance exceeding the width of the tire 12 and wheel 18. Then the pad 27 on the outer arm 30 is positioned on the outer edge of the outer wheel rim 24 and the inner arm 9 engages the inner tire 12 sidewall. Further, the outer index stop 21 is engaged to the outer diameter of the inner wheel rim 24 adjacent the inner sidewall of the tire 12 and the inner index stop 15 is engaged to the inner diameter of the wheel 18. After the immobilizer first half 3 is positioned, the bolt 36 located inside the cylinder 75 is turned clockwise until it applies pressure on the end of the inner arm 9 that is hingedly interconnected to the base 69 thus prohibiting movement of the inner index stop 15 of the inner arm 9 away from the outer arm 30 which prevents disengagement of the vehicle immobilizer device 60 from the tire 12 and wheel 18.

The immobilizer second half 6 is used to prevent the removal of the immobilizer first half 3. The second half 6 is positioned with the plate 42 of the second half 6 substantially covering the outer arm 30 of the first half 3 wherein the stud 39 of the first half 3 is aligned with the adjustment slot 45 of the second half 6. The telescoping feature of the beam 81 and sleeve 87 and the hinged connection between the dome 63 and the sleeve 87 are utilized to position the dome 63 securely over all of the lug nuts 66 of the wheel 18, which prevents the removal of the wheel 18 with the vehicle immobilization device 60 in place. When the dome 63 is in position, the nut 51 is attached to the stud 39 to secure the immobilizer second half 6 to the immobilizer first half 3. Finally, the housing cover 54 is placed over the housing 48 wherein the protrusion 96 extends into the channel 90 to ensure the proper alignment of the cover 54. A padlock 57 is then inserted through the matching apertures 99 in the channel 90 and protrusion 96 that line up when the cover 54 is properly placed to effectively secure the vehicle immobilization device 60.

Embodiments of the present invention are constructed of steel, however, other materials such as aluminum, plastic, or composite materials may be utilized depending on the requisite strength, weight, and cost factors. Further, the size and thickness of the various components of the immobilizer are variable depending on the above factors.

While various embodiments of the present invention have been described in detail, it is apparent that modifications and alterations of these embodiments will occur to those skilled in the art. However, it is to be expressly understood that such modifications and alterations are within the scope and sphere of the present invention as set forth in the following claims.

What is claimed is:

1. A two-piece vehicle immobilizing apparatus adapted for use with a vehicle wheel assembly including a wheel, a wheel rim interconnected to said wheel, and a tire interconnected to said wheel rim, comprising:
a first half that includes:
a base,
an outer arm having a first end and a second end, said first end interconnected to said base,
an inner arm having a first end and a second end, said first end hingedly interconnected to said base, and
an indexing loop interconnected to said second end of said inner arm for engagement with the wheel;
a securing member selectively interconnected to said base that engages said first end of said inner arm, thereby preventing said second end of said inner arm from moving outwardly from said second end of said outer arm; and
a second half for selective interconnection to said first half that includes:
a dome for engagement to the wheel interconnected to said outer arm second end of said first half.

2. The apparatus of claim 1 further, comprising a spring interconnected to said inner arm and said base.

3. The apparatus of claim 1, wherein said securing member is a bolt that is threadingly engaged to said base.

4. The apparatus of claim 1, further including a pad interconnected to said second end of said outer arm and a cushion interconnected to the lip of the dome.

5. The apparatus of claim 1, further including at least one stand interconnected to said base.

6. The apparatus of claim 1, wherein said second half further includes:
a plate that obstructs said securing member when said first half and said second half are interconnected;
a beam interconnected to said plate;
a sleeve slidingly interconnected to said beam and rotatably interconnected to said dome.

7. The apparatus of claim 6, wherein said plate includes an aperture that receives a stud positioned on said outer arm of said first half, wherein the stud is adapted to receive a nut to secure said first half and said second half together.

8. The apparatus of claim 7, further comprising a housing that obscures said stud and nut when said first half and said second half are interconnected, said housing also adapted to receive a cover that prevents access to said nut.

9. A vehicle immobilizing apparatus adapted for engagement to a wheeled assembly, comprising:
a first half that includes:
a base,
an outer means for engaging a wheel interconnected to said base, and
an inner means for engaging a wheel, which has a first end and a second end, hingedly interconnected to said base;
a means for restricting interconnected to said base that selectively engages one end of said inner means for engaging a wheel, thereby preventing a second end of said inner means for engaging a wheel from moving outwardly from said outer means for engaging a wheel; and
a second half that includes:
a means for obstructing lug nuts of the wheel selectively interconnected to said outer arm second end of said first half.

10. The apparatus of claim 9, further comprising a means for biasing interconnecting said inner means for engaging a wheel to said base.

11. The apparatus of claim 9, wherein said means for restricting is a bolt that is threadingly engaged to said base.

12. The apparatus of claim 9, further including at least one means for supporting interconnected to said base.

13. The apparatus of claim 9, wherein said second half further includes:
a plate that obstructs said restricting means when said first half and said second half are interconnected;
a beam interconnected to said plate;
a sleeve slidingly interconnected to said beam and rotatably interconnected to said means for obstructing lug nuts.

14. The apparatus of claim 13, wherein said plate includes an aperture that receives a stud positioned on said outer means for engaging a wheel of said first half, wherein the stud is adapted to receive a nut to secure said first half and said second half together.

15. The apparatus of claim 14, further comprising a housing that obscures said stud and nut when said first half and said second half are interconnected.

16. A method of immobilizng a vehicle having a vehicle wheel assembly including a wheel, a wheel rim interconnected to said wheel, and a tire interconnected to said wheel rim, comprising:
providing a base assembly with an inner arm rotatably associated with an outer arm, which has a threaded stud protruding therefrom, and a securing member that selectively prevents said inner arm from moving outwardly from said outer arm;
interconnecting said inner arm to an inner portion of the wheel rim;
interconnected said outer arm to an outer portion of the wheel rim;
tightening said securing member, thereby fastening said base assembly to the vehicle wheel assembly;
providing a dome assembly with a plate with an aperture therein interconnected to a beam, wherein said beam is also slidingly engaged to a sleeve that is rotatably interconnected to a dome;
positioning said dome over the wheel;
selectively adjusting said sleeve to position said stud through said aperture;
tightening a nut onto said stud to interconnect said base assembly to said dome assembly.

17. The method of claim 16, further comprising providing a housing and cover interconnected to said dome assembly that obstructs the nut.
